(19) United States
(12) Patent Application Publication
(10) Pub. No.: US 2024/0358024 A1
(43) Pub. Date: Oct. 31, 2024

(54) SUBSTRATES FOR PLANT GROWTH AND INFRASTRUCTURE

(71) Applicant: Khalifa University of Science and Technology, Abu Dhabi (AE)

(72) Inventors: Blaise Leopold TARDY, Abu Dhabi (AE); M-Hidar Ali AL DALI, Abu Dhabi (AE); Mohamed Hamid SALIM, Abu Dhabi (AE); Ghanim Mabrook Firuz MABROOK, Abu Dhabi (AE)

(21) Appl. No.: 18/645,560

(22) Filed: Apr. 25, 2024

Related U.S. Application Data
(60) Provisional application No. 63/461,714, filed on Apr. 25, 2023.

(51) Int. Cl. A01N 63/20; A01N 25/10; A01P 21/00

(52) U.S. Cl. CPC A01N 63/20; A01N 25/10; A01P 21/00

(57) ABSTRACT

A method for forming a fibrous network in a substrate includes introducing a first additive and a second additive to sandy soil sufficient to form a fibrous composite, wherein the first additive includes one or more sugars, and wherein the second additive includes microbes.

### CROSS-REFERENCE TO RELATED APPLICATION

This application claims benefit of U.S. Provisional Application No. 63/461,714, filed on Apr. 25, 2023. U.S. Provisional Application No. 63/461,714 is incorporated herein by reference. A claim of priority is made.

### TECHNICAL FIELD

The subject matter disclosed herein relates broadly to the fields of agriculture and soils, and in particular, to substrates for plant growth and/or infrastructure.

### BACKGROUND

Certain soil types can be used as growing substrates and for stabilization for infrastructure applications. Growing substrates, such as soil containing an abundance of organic matter, have been used to assist with plant growth. Certain growing substrates can serve as a reservoir for moisture and nutrients around the roots of plants. Further, these growing substrates can also provide support for the plant and pore space for oxygen around the roots. In contrast, desertic areas have an abundance of sandy soil. Unfortunately, this sandy soil is highly erodible (through wind and physical deformation), has poor water and nutrient retention, and has little to no organic matter. Organic matter is an important component for water and nutrient transport. Further, organic matter can assist in preventing erosion. Unfortunately, since organic matter is nearly absent in the sandy soils of arid areas, many plants are not able to efficiently grow in these areas. Therefore, conventional sandy soil does not exhibit many of the important growing substrate characteristics for efficiently growing plants. Further, many buildings and infrastructure applications utilize foundations or support structures within or on the ground to stabilize the structure. When these structures are built on sandy soil that is easily movable and erodible, these structures can be susceptible to stabilization and movement issues.

### SUMMARY

According to one aspect, a method for forming a fibrous network in a substrate includes introducing a first additive and a second additive to sandy soil sufficient to form a fibrous composite, wherein the first additive includes one or more sugars, and wherein the second additive includes microbes.

According to another aspect, a method for forming a fibrous network in a substrate includes introducing cellulose fibers to sandy soil sufficient to form a fibrous composite, wherein the cellulose fibers include mechanically processed cellulose fibers using a ball-milling process or a high-pressure homogenizer.

According to another aspect, a method for forming a sandy soil composite includes (a) blending one or more plant materials, wherein the one or more plant materials include cellulose fibers; (b) treating the one or more plant materials; and (c) introducing the cellulose fibers to sandy soil, wherein the sandy soil includes at least 75 wt. % sand particles having a diameter ranging from about 0.02 mm to about 10 mm.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates method 100 for forming a fibrous network in a substrate, according to some embodiments.

FIG. 2 illustrates method 200 for forming a fibrous network in a substrate, according to some embodiments.

FIG. 3 illustrates method 300 for forming a sandy soil composite, according to some embodiments.

FIG. 4A illustrates a microbial network of cellulose formed from waste nutrients, according to some embodiments.

FIG. 4B illustrates sandy soil to be used for in situ growth of bacteria, according to some embodiments.

FIG. 4C illustrates sandy soil composites after bacterial growth, according to some embodiments.

FIG. 4D illustrates sandy soil composites after bacterial growth, according to some embodiments.

FIG. 4E illustrates the sandy soil composite immersed under water, highlighting its resistance to erosion and associated water retention, according to some embodiments.

FIG. 5 illustrates the stability of sandy soil composites stabilized by bacterial exopolysaccharides in water and scanning electron microscopy (SEM) images of the sandy soil composites, according to some embodiments.

FIG. 6A illustrates toughness in MJ m⁻³ at 25% strain for 1.06% dry-weight nanocellulose in the sandy soil composite, according to some embodiments.

FIG. 6B illustrates ultimate compressive strength (UCS) in MPa for the sandy soil composites as a function of added nanocellulose for 1.06% dry weight nanocellulose in the sandy soil composites, according to some embodiments.

FIG. 7A illustrates toughness at 25% in MJ m⁻³ as a function of polymer composition in the sandy soil composite, according to some embodiments.

FIG. 7B illustrates ultimate compressive strength (UCS) for the sandy soil composite as a function of dry weight percentage of nanocellulose, according to some embodiments.

FIG. 8A illustrates representative stress-strain curves at 25% relative humidity for Kraft Pulp (KP) of unconfined compression tests, according to some embodiments.

FIG. 8B illustrates representative stress-strain curves at 25% relative humidity for cellulose nanofibers at 2.12% (CNF 2X) of unconfined compression tests, according to some embodiments.

FIG. 8C illustrates representative stress-strain curves at 25% relative humidity for hydroxypropylcellulose (HPC) of unconfined compression tests, according to some embodiments.

FIG. 8D illustrates representative stress-strain curves at 25% relative humidity for carboxymethylcellulose (CMC) 0.7 of unconfined compression tests, according to some embodiments.

FIG. 8E illustrates representative stress-strain curves at 25% relative humidity for carboxymethylcellulose (CMC) 0.09 of unconfined compression tests, according to some embodiments.

FIG. 9 illustrates a flowchart showing interactions between sand granules and polymer phases, where (b, c: nanofibers and large polymers such as CMC 0.7; d, e: short polymers such as CMC 0.09; f, g: strongly adhesive polymers such as chitosan), according to some embodiments.

FIG. 10A illustrates toughness in MJ m⁻³ for the sandy soil composites as a function of carbohydrate polymers added after a 25% strain, according to some embodiments.

FIG. 10B illustrates relative change in average toughness resulting for samples exposed to 25% RH or >95% RH prior to compression, according to some embodiments.

FIG. 10C illustrates corresponding ultimate compressive strength (UCS), according to some embodiments.

FIG. 10D illustrates the strain at the ultimate compressive strength, according to some embodiments.

FIG. 11A illustrates a scanning electron microscopy (SEM) image of sandy soil composites formed with CMC 0.09, according to some embodiments.

FIG. 11B illustrates a scanning electron microscopy (SEM) image of sandy soil composites formed with CMC 0.09, according to some embodiments.

FIG. 11C illustrates a scanning electron microscopy (SEM) image of sandy soil composites formed with CMC 0.7, according to some embodiments.

FIG. 11D illustrates a scanning electron microscopy (SEM) image of sandy soil composites formed with CMC 0.7, according to some embodiments.

FIG. 11E illustrates a scanning electron microscopy (SEM) image of sandy soil composites formed with CNF 2X, according to some embodiments.

FIG. 11F illustrates a scanning electron microscopy (SEM) image of sandy soil composites formed with CNF 2X, according to some embodiments.

FIG. 12A illustrates changes in mass for the sandy soil composites as a function of relative humidity, according to some embodiments.

FIG. 12B illustrates the mass change normalized to the polymer content after subtraction of the corresponding change in mass for the control, according to some embodiments.

FIG. 13A illustrates a representative water adsorption isotherm from sandy soil composites consolidated with CMC 0.09, according to some embodiments.

FIG. 13B illustrates representative water adsorption isotherms for the 80-95 RH transition in sandy soil composites containing CMC 0.7, CMC 0.09, CNF 2X, or no amendments (control sand), according to some embodiments.

FIG. 13C illustrates water uptake constant or step response constant corresponding to the time required to reach 63.2% ((1−1/e)·100%) of the plateaued isotherm, according to some embodiments.

FIG. 13D illustrates the corresponding ratio of uptake to release rates, according to some embodiments.

FIG. 14A illustrates moisture loss over time for fibers obtained from various treatments at 1% amendment, where R-PA=raw pineapple peel, AT=alkali treated, BL=bleached, BM=ball milled, according to some embodiments.

FIG. 14B illustrates a comparison of nanofibers with other sand amendments at 5% amendment, according to some embodiments.

FIG. 15A illustrates potassium retention of sands, according to some embodiments.

FIG. 15B illustrates phosphorus retention of sands, according to some embodiments.

FIG. 16 illustrates plant growth using micro-and nanofiber treated sand, according to some embodiments.

FIG. 17A illustrates sieve analysis of first sandy soil S1, according to some embodiments.

FIG. 17B illustrates sieve analysis of second sandy soil S2, according to some embodiments.

FIG. 17C illustrates sieve analysis of third sandy soil S3, according to some embodiments.

FIG. 18 illustrates toughness of sandy soils S1, size fractions of S1, S2, and S3, with CMC 0.7 utilized, according to some embodiments.

FIG. 19A illustrates morphology analysis of raw pineapple peel (R-PA), according to some embodiments.

FIG. 19B illustrates morphology analysis of R-PA, according to some embodiments.

FIG. 19C illustrates morphology analysis of R-PA after ball milling, according to some embodiments.

FIG. 19D illustrates fiber size analysis of R-PA after ball milling (R-PA BM), according to some embodiments.

FIG. 20A illustrates morphology analysis of alkali treated pineapple peel (AT PA), according to some embodiments.

FIG. 20B illustrates morphology analysis of AT PA, according to some embodiments.

FIG. 20C illustrates morphology analysis of AT PA after ball milling, according to some embodiments.

FIG. 20D illustrates fiber size analysis of AT PA after ball milling (AT PA BM), according to some embodiments.

FIG. 21A illustrates morphology analysis of bleached pineapple peel (BL PA), according to some embodiments.

FIG. 21B illustrates morphology analysis of BL PA, according to some embodiments.

FIG. 21C illustrates morphology analysis of BL PA after ball milling, according to some embodiments.

FIG. 21D illustrates fiber size analysis of BL PA after ball milling (BL PA BM), according to some embodiments.

FIG. 22 illustrates the average diameter of R-PA, AT PA, and BL PA after ball milling, according to some embodiments.

FIG. 23 illustrates the gelling point (%) of R-PA, AT PA, and BL PA, with and without ball milling, according to some embodiments.

FIG. 24A illustrates toughness of R-PA, AT PA, and BL PA, with and without ball milling, according to some embodiments.

FIG. 24B illustrates E-modulus of R-PA, AT PA, and BL PA, with and without ball milling, according to some embodiments.

FIG. 25A illustrates ultimate compressive strength of R-PA, AT PA, and BL PA, with and without ball milling, according to some embodiments.

FIG. 25B illustrates strain at ultimate stress of R-PA, AT PA, and BL PA, with and without ball milling, according to some embodiments.

FIG. 26 illustrates phosphorous retained (%) for control and for R-PA, AT PA, and BL PA, with and without ball milling, according to some embodiments.

### DETAILED DESCRIPTION

The present disclosure provides sandy soil composites and methods for producing sandy soil composites for enhanced soil and plant growth characteristics. While sandy soil is abundant in many regions throughout the world, sandy soil is highly erodible (through wind and physical deformation), has poor water and nutrient retention, and has little to no organic matter. Additionally, sandy soil does not provide robust support for plant structures. Sandy soil composites of the present disclosure exhibit improved water and nutrient retention, and these composites provide enhanced structural support for plants. These sandy soil composites can be formed using plant and food based waste materials and can include polysaccharide fiber networks.

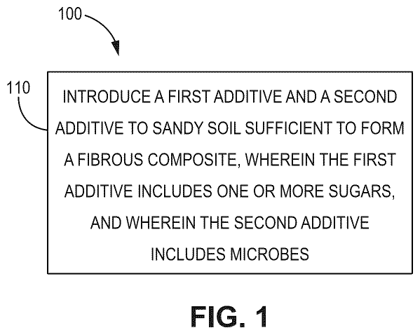

FIG. 1 illustrates method 100 for forming a fibrous network in a substrate, according to some embodiments. In one non-limiting example, method 100 forms a nanofibrous network in the substrate. Method 100 includes the following step: At Step 110, a first additive and a second additive are introduced to sandy soil sufficient to form a fibrous composite, wherein the first additive includes one or more sugars, and wherein the second additive includes microbes. The first additive may be introduced to the sandy soil before, concurrently, and/or after the second additive is introduced to the sandy soil. Adding the first additive and the second additive to the sandy soil may include contacting the first additive and the second additive with the sandy soil. In one example, the second additive is introduced to the sandy soil prior to the first additive being introduced to the sandy soil. Importantly, method 100 can be used for various substrates, such as substrates other than sandy soil. For example, method 100 could be used in clays, silts, loams, and/or various topsoils. In one example, the substrate includes a granular or particulated substrate. For example, the substrate can include a porous granular substrate. The substrate generally includes sandy soils of the present disclosure.

The first additive includes one or more sugars. The one or more sugars may be dissolved, or substantially dissolved, in liquid (such as a liquid including water). Sugar may include one or more elements including carbon, hydrogen, and oxygen. In one example, sugars include carbohydrates dissolvable (or at least substantially dissolvable) in water. Sugars may include at least one of monosaccharides and disaccharides. Monosaccharides may follow the formula: (CH₂O)ₓ. In one example, x is 3 or greater. Examples of monosaccharides include glucose, fructose, galactose, and ribose. Disaccharides can include sugar formed from two monosaccharides. Examples of disaccharides include sucrose, lactose, and maltose. In one non-limiting example, the one or more sugars includes glucose.

The first additive can be sourced from a water-dissolvable food waste fraction, including various plant-based wastes such as fruits and vegetables, or pulp and paper by-products treated with enzymes. In one example, the one or more sugars are obtained from organic waste, such as organic food waste. In another example, the one or more sugars are obtained from plant material. For example, the plant material may include at least one of fruit, flowers, stalks, trunks, vegetables, stems, roots, and leaves. The plant material may be mechanically processed sufficient to form a dissolved fraction and an undissolved fraction, wherein the one or more sugars are included in the dissolved fraction. For example, the plant material may be mechanically processed using a blender. The dissolved fraction may be added directly to the sandy soil.

The second additive includes microbes, such as at least one strain of microbes. The second additive may also include a liquid, such as water. Microbes include microorganisms, such as bacterium. In one example, the microbes include microbes capable of excreting exopolysaccharides. For example, exopolysaccharides include viscous carbohydrate polymers formed by bacteria. In one example, the microbes are capable of producing cellulose. Microbes capable of producing cellulose include bacteria of the Komagataeibacter genus, the Acetobacter genus, Gluconobacter genus, Agrobacteriumgenus, Achromobacter genus, Enterobacter genus, Rhizobium genus, Pseudomonas genus, Salmonella genus, Bacillus genus, Sarcina genus, and Rhodococcus genus. Examples of microbes in the Komagataeibacter genus include K. medellinensis, K. xylinus, and K. hansenii.

The sandy soil can include at least one of rock particles and mineral particles. These particles can include one or more of limestone, shale, granite, and quartz. This sandy soil generally includes a low percentage of organic material. Accordingly, sandy soil is very weakly structured for plant growth and support. Due to the large pores between sand particles, water and nutrients leach out of the sandy soil quickly. Due to these disadvantages of sandy soil, it has traditionally been very difficult to efficiently grow plants in sandy soil. Sandy soil may include a majority of sand sized particles, and this sandy soil may include fine, medium, and/or coarse sand particles.

In one example, sandy soil includes at least 50 wt. % sand particles having a diameter ranging from about 0.02 mm to about 10 mm. In another example, sandy soil includes at least 60 wt. % sand particles having a diameter ranging from about 0.02 mm to about 10 mm. In yet another example, sandy soil includes at least 75 wt. % sand particles having a diameter ranging from about 0.02 mm to about 10 mm. In one example, sandy soil includes at least 50 wt. % sand particles having a diameter ranging from about 0.05 mm to about 2 mm. In another example, sandy soil includes at least 60 wt. % sand particles having a diameter ranging from about 0.05 mm to about 2 mm. In yet another example, sandy soil includes at least 80 wt. % sand particles having a diameter ranging from about 0.05 mm to about 2 mm.

In one example, the average particle size of particles in sandy soil is greater than 0.02 mm. In another example, the average particle size of particles in sandy soil is greater than 0.1 mm. In yet another example, the average particle size of particles in sandy soil is less than 5 mm. In yet another example, the average particle size of particles in sandy soil is less than 0.6 mm. Sandy soil may include one or more of clay and silt. In one example, the average particle diameter of silt particles ranges from about 0.002 mm to about 0.05 mm, and the average particle diameter of clay particles is less than 0.002 mm. Sandy soil may include less than 25 wt. % silt and less than 25 wt. % clay. Sandy soil may include less than 10 wt. % silt and less than 10 wt. % clay. In one example, sandy soil includes less than 5 wt. % silt. In another example, sandy soil includes less than 5 wt. % clay. In one non-limiting example, sandy soil includes less than 5 wt. % of combined clay and silt. In another non-limiting example, sandy soil includes less than 2 wt. % of combined clay and silt.

Introducing the first additive and the second additive to the sandy soil may include contacting the first additive and the second additive. The first additive and the second additive may be introduced at various temperatures and relative humidities. For example, the first additive and the second additive may be introduced to the sandy soil at temperatures ranging from about 15° C. to about 50° C. Introducing the first additive and the second additive can be sufficient for microbial growth and the formation of cellulose fibers. In one example, introducing the first additive to the second additive is sufficient for microbial growth, wherein the fibrous network is formed during growth. The growth of the microbe can be accompanied by excretion of exopolysaccharides, the majority of which can be cellulose nanofibers. In another example, method 100 may be performed without the addition of urea and/or calcium. In yet another example, method 100 does not require mineralization.

The formed fibrous composite includes cellulose fibers. Cellulose fibers can include pulp fibers and the smaller fibers obtained from pulp fibers such as nanocellulose fibers (CNFs), microfibrillated cellulose, and/or cellulose nanocrystals (CNCs). Microbially synthesized nanofibers include microbial nanocellulose. Accordingly, the fibrous composite can include the sandy soil and at least one of microcellulose fibers and nanocellulose fibers. The cellulose fibers may form bridges between separate particles of the sandy soil.

Accordingly, the cellulose fibers can be in contact with particles of the sandy soil. Therefore, the cellulose fibers increase cohesion of particles within the fibrous composite. The fibrous composite exhibits increased cohesion, enhancing the mechanical strength and water response, compared to the initial sandy soil.

The cellulose fibers may include fibers having an average diameter ranging from about 1 nm to about 100 nm. In one example, the cellulose fibers include fibers having an average diameter ranging from about 20 nm to about 50 nm. In another example, the cellulose fibers include fibers having an average diameter ranging from about 2 nm to about 30 nm. The cellulose fibers may include fibers having an average length greater than about 10 nm. In one example, the cellulose fibers include fibers having a length greater than 50 nm. In another example, the cellulose fibers include fibers having a length ranging from about 10 nm to about 100 microns. In yet another example, the cellulose fibers include fibers having a length ranging from about 100 nm to about 10 microns.

The fibrous composite includes the cellulose fibers and the sandy soil. The weight percentage of cellulose fibers in the fibrous composite may be greater than about 0.01 wt. %. In one example, the weight percentage of cellulose fibers in the fibrous composite is greater than about 0.1 wt. %. In another example, the weight percentage of cellulose fibers in the fibrous composite ranges from about 0.1 wt. % to about 5 wt. %. In another example, the weight percentage of cellulose fibers in the fibrous composite ranges from about 0.1 wt. % to about 3 wt. %. In yet another example, the weight percentage of cellulose fibers in the fibrous composite ranges from about 0.5 wt. % to about 2 wt. %.

In one example, conventional soil amendments require composting, whereby a large amount of mass is lost, cohesion strength is lost, and a composting center is generally required. In another example, conventional soil amendments require clay and/or exfoliated clay (nanoclay) addition, which is expensive and can require importation. In another example, conventional soil amendments can require high-cost and non-biodegradable, synthetic polymers. In yet another example, conventional soil amendments can require gums, which are generally less fit for agricultural uses as they are a food source, and the resulting soils are more prone to erosion. Therefore, the present methods can be lower cost, exhibit enhanced properties for agricultural purposes, and can be made using organic materials, such as plant materials.

Importantly, method 100 may be used to form a fibrous composite with a robust cellulose network using sandy soil and additives. These fibrous composites exhibit enhanced stability, water and nutrient retention, and water and wind erosion resistance compared to conventional sandy soil. Further, the first additive can include one or more sugars, such as sugars from plants and organic waste materials. For example, the first additive may be formed from fruit and/or vegetable waste. Therefore, fibrous composites may be formed using portions or products of waste materials, assisting in utilizing these otherwise unused waste materials. Fibrous composites of the present disclosure can be used for enhanced plant growth compared to traditional sandy soil, and these composites can also be used for structural applications to increase stability of the structure, such as for buildings and railroad tracks.

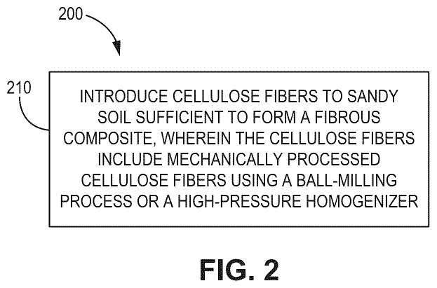

FIG. 2 illustrates method 200 for forming a fibrous network in a substrate, according to some embodiments. Method 200 may include forming a nanofibrous network. Method 200 includes the following step: At Step 210, cellulose fibers are introduced to sandy soil sufficient to form a fibrous composite, wherein the cellulose fibers include mechanically processed cellulose fibers using a ball-milling process or a high-pressure homogenizer. In one example, the substrate includes a granular or particulated substrate. For example, the substrate can include a porous granular substrate. The substrate generally includes sandy soils of the present disclosure.

The cellulose fibers may be included in a liquid. In one example, the cellulose fibers are included in an aqueous suspension. In another example, the cellulose fibers are included in an aqueous solution. Accordingly, the cellulose fibers may be present in a water-containing liquid. In one example, the weight percentage of cellulose fibers in the liquid ranges from about 0.1 wt. % to about 10 wt. %. In another example, the weight percentage of cellulose fibers in the liquid ranges from about 0.5 wt. % to about 7 wt. %. In yet another example, the weight percentage of cellulose fibers in the liquid ranges from about 1 wt. % to about 4 wt. %. For example, the weight percentage of cellulose fibers in the liquid may be about 2 wt. %, about 2.5 wt. %, about 3 wt. %, or about 3.5 wt. %. The weight percentage of cellulose fibers in the liquid may be greater than 1 wt. %. The weight percentage of cellulose fibers in the liquid may be greater than 2 wt. %.

The liquid may further include an acid, such as in the form of an acidic solution. For example, the liquid includes water and an acid. One suitable example of an acid is hydrochloric acid. This acid may be added to reduce the pH value of the liquid. In one example, the pH value of the liquid is below about pH 8. In another example, the pH value of the liquid is below pH 7. In another example, the pH value of the liquid ranges from about pH 4 to about pH 7. In yet another example, the pH value of the liquid ranges from about pH 4 to about pH 6. For example, the pH value of the liquid may be about pH 4, about pH 5, or about pH 6.

The cellulose fibers may include one or more of microcellulose, microfibrillated cellulose, nanocellulose fibers, and cellulose nanocrystals. In one non-limiting example, the cellulose fibers include at least nanocellulose fibers. The cellulose fibers may include fibers having an average diameter ranging from about 1 nm to about 100 nm. In one example, the cellulose fibers include fibers having an average diameter ranging from about 20 nm to about 50 nm. In another example, the cellulose fibers include fibers having an average diameter ranging from about 2 nm to about 30 nm. The cellulose fibers may include fibers having an average length greater than about 10 nm. In one example, the cellulose fibers include fibers having a length greater than 50 nm. In another example, the cellulose fibers include fibers having a length ranging from about 10 nm to about 100 microns. In yet another example, the cellulose fibers include fibers having a length ranging from about 100 nm to about 10 microns.

The cellulose fibers include mechanically processed cellulose fibers using a ball-milling process or a high-pressure homogenizer. In one example, the mechanically processed cellulose fibers include at least one of microcellulose fibers and nanocellulose fibers. The ball-milling process can include grinding and/or blending material using a ball-milling system. The ball-milling process utilizes one or more rotating cylinders (or chambers) and a plurality of balls to grind the material. The balls may be made of various metals, alloys such as stainless steel, or ceramics. In one example, the balls include zirconia. The balls may have diameters sufficient for ball-milling, such as a diameter ranging from about 1 mm to about 10 mm. In one example, the diameters of the balls range from about 2 mm to about 7 mm. The fibers may be ball-milled in the fiber solutions and/or fiber suspensions of the present disclosure. Following the ball-milling process, the balls can be separated using various sieving and separation techniques. In one example, the solution can be condensed via centrifugation.

As discussed, the cellulose fibers can include mechanically processed cellulose fibers using a high-pressure homogenizer. The homogenizer can receive a stream and can homogenize and/or reduce particle sizes of components. The homogenizer can submit the cellulose fibers to shear forces. In one example, the homogenizer can operate at pressures ranging from 10 bar to 3000 bar. The mechanically processed cellulose fibers can include cellulose fibers from organic material. In one example, organic material includes one or more of plant material and food material. For example, the plant material may include at least one of fruit, flowers, stalks, trunks, vegetables, stems, roots, and leaves. The food material can include one or more of fruits and vegetables. In another example, organic material includes fruits, vegetables, municipal trimmings, and/or pulp and paper by-products. One example of organic material is pulp.

In one example, the organic material is blended prior to being subjected to the ball-milling process or high-pressure homogenizer. For example, blending organic material can be sufficient to form a dissolved fraction and an undissolved fraction. The dissolved fraction may be a liquid including one or more sugars, and the undissolved fraction may include cellulose fibers. The undissolved fraction may be formed by sedimentation, and the undissolved fraction can include the majority of the cellulose fibers. Therefore, the undissolved fraction, including the cellulose fibers, can be transferred to the ball-milling process. In one example, hot water treatment may be used prior to ball-milling. Hot water treatment may utilize water at a temperature above about 25° C., above about 30° C., or above about 50° C. Hot water treatment may be utilized to remove pectin, soluble sugars, phenolics, and/or minerals.

Prior to, or after, ball-milling or processing using the high-pressure homogenizer, cellulose fibers and/or other organic material may be treated using one or more of the following methods: alkali treatment, tempo oxidation, and bleaching. Alkali treatment may include adding cellulose fibers to an aqueous solution, such as a solution of sodium hydroxide or potassium hydroxide. The aqueous solution for alkali treatment may have a pH value of greater than about pH 7. In one example, the aqueous solution for alkali treatment has a pH value of greater than about pH 8. Alkali treatment may be sufficient to modify the surface chemistry of the cellulose fibers and/or to remove residues such as hemicellulose.

Tempo oxidation may include using 2,2,6,6-Tetramethylpiperidine-1-oxyl radical (TEMPO) for catalyzed oxidation. In one example, tempo oxidation includes using one or more of TEMPO, NaBr, and NaClO in water. In another example, tempo oxidation includes using one or more of 4-acetamido-TEMPO, NaClO, and NaClO₂. Tempo oxidation can be utilized to produce oxidized cellulose. Tempo oxidation may be completed at a pH value above about 7 pH. In one example, tempo oxidation is completed at a pH value above about 9 pH. This reaction can be completed at room temperature, such as about 15° C. to about 25° C. Bleaching may be utilized to remove one or more impurities. Bleaching may include contacting cellulose fibers with an aqueous solution, such as a liquid containing peroxides. In one example, bleaching includes contacting cellulose fibers with hydrogen peroxide. In another example, bleaching includes contacting cellulose fibers with one or more oxygen-containing compounds. In yet another example, bleaching includes chemical bleaching with one or more of sodium hypochlorite, chlorine, chlorine dioxide, and alkaline peroxide.

In one example, sandy soil includes at least 50 wt. % sand particles having a diameter ranging from about 0.02 mm to about 10 mm. In another example, sandy soil includes at least 60 wt. % sand particles having a diameter ranging from about 0.02 mm to about 10 mm. In yet another example, sandy soil includes at least 75 wt. % sand particles having a diameter ranging from about 0.02 mm to about 10 mm. In one example, sandy soil includes at least 50 wt. % sand particles having a diameter ranging from about 0.05 mm to about 2 mm. In another example, sandy soil includes at least 60 wt. % sand particles having a diameter ranging from about 0.05 mm to about 2 mm. In yet another example, sandy soil includes at least 80 wt. % sand particles having a diameter ranging from about 0.05 mm to about 2 mm.

In one example, the average particle size of particles in sandy soil is greater than 0.02 mm. In another example, the average particle size of particles in sandy soil is greater than 0.1 mm. In yet another example, the average particle size of particles in sandy soil is less than 5 mm. In yet another example, the average particle size of particles in sandy soil is less than 0.6 mm. Sandy soil may include one or more of clay and silt. In one example, the average particle diameter of silt particles ranges from about 0.002 mm to about 0.05 mm, and the average particle diameter of clay particles is less than 0.002 mm. Sandy soil may include less than 25 wt. % silt and less than 25 wt. % clay. Sandy soil may include less than 10 wt. % silt and less than 10 wt. % clay. In one example, sandy soil includes less than 5 wt. % silt. In another example, sandy soil includes less than 5 wt. % clay. In one non-limiting example, sandy soil includes less than 5 wt. % of combined clay and silt. In another non-limiting example, sandy soil includes less than 2 wt. % of combined clay and silt.

The fibrous composite includes the cellulose fibers. Accordingly, the fibrous composite can include the sandy soil and at least one of microcellulose fibers and nanocellulose fibers. The cellulose fibers may form bridges between separate particles of the sandy soil. Accordingly, the cellulose fibers can be in contact with particles of the sandy soil. Therefore, the cellulose fibers increase cohesion of particles within the fibrous composite. Importantly, the fibrous composite can exhibit increased cohesion, enhancing the mechanical strength and water response, compared to the initial sandy soil.

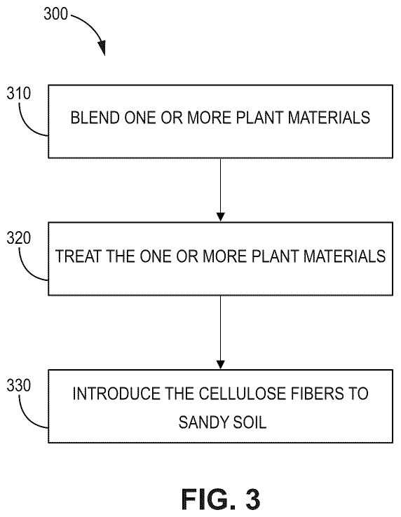

FIG. 3 illustrates method 300 for forming a sandy soil composite, according to some embodiments. Method 300 includes one or more of the following steps (with various orders possible):

At Step 310, one or more plant materials are blended. For example, the plant material may include at least one of fruit, flowers, vegetables, stems, roots, and leaves. Blending may include utilizing a blender sufficient to grind, mix, stir, and/or contact the one or more plant materials. The one or more plant materials may be contacted with a liquid during blending, such as a water-containing liquid. Blending the plant materials can be sufficient to form an undissolved fraction and a dissolved fraction. The undissolved fraction can include cellulose fibers, and the dissolved fraction can include one or more sugars. The cellulose fibers can be separated by sedimentation.

At Step 320, the one or more plant materials are treated. The plant materials include cellulose fibers. Step 320 can be performed before or after Step 310. In one example, treating the one or more plant materials includes ball-milling the one or more plant materials. In another example, a high-pressure homogenizer may be used for treatment. The ball-milling process can include grinding and/or blending material using a ball-milling system. The ball-milling process can utilize one or more rotating cylinders (or milling chambers) and a plurality of balls to grind and/or crush the material. The balls may be made of various metals, alloys such as stainless steel, rubber, or ceramics. The balls may have diameters sufficient for ball-milling, such as a diameter ranging from about 1 mm to about 10 mm. In one example, the diameters of the balls range from about 2 mm to about 7 mm.

The cellulose fibers may be ball-milled in fiber solutions or suspensions. In one example, the weight percentage of cellulose fibers in the solution may range from about 0.5 wt. % to about 12 wt. %. In another example, the weight percentage of cellulose fibers in the solution may range from about 1wt. % to about 10 wt. %. In another example, the weight percentage of cellulose fibers in the solution may range from about 1 wt. % to about 3 wt. %. Following the ball-milling process, the balls can be separated using various sieving and separation techniques. In one example, the solution can be condensed via centrifugation. Step 320 may further include one or more of alkali treatment, tempo oxidation, and bleaching, as discussed in the present disclosure.

Prior to Step 330, a dissolved fraction including one or more sugars (as discussed in method 100) may be formed from the plant material. These one or more sugars can be at least partially separated from the cellulose fibers of the plant material. Accordingly, method 300 may also be utilized to prepare the one or more sugars of method 100. The one or more sugars can be added to sandy soil with microbes (such as the microbes of the present disclosure) sufficiently for the microbes to produce nanocellulose fibers.

At Step 330, the cellulose fibers are introduced to sandy soil. Introducing the cellulose fibers to sandy soil can include contacting the cellulose fibers with the sandy soil. In one example, cellulose fibers can be infiltrated into the sandy soil using centrifugation. In another example, cellulose fibers can be combined with sandy soil by forming a slurry with the cellulose fibers using mixing. In one example, the cellulose fibers are present in a suspension or a solution. For example, the cellulose fibers may be present in a water-containing liquid. In one example, the weight percentage of cellulose fibers in the suspension or solution ranges from about 0.5 wt. % to about 10 wt. %. In another example, the weight percentage of cellulose fibers in the suspension or solution ranges from about 1 wt. % to about 5 wt. %. In yet another example, the weight percentage of cellulose fibers in the suspension or solution ranges from about 1 wt. % to about 3 wt. %. The sandy soil and/or cellulose fibers can be dried to form the sandy soil composite. For example, the sandy soil and/or cellulose fibers can be dried at a temperature above about 30° C. to form the sandy soil composite. In one example, the sandy soil and/or cellulose fibers can be dried at a temperature above about 100° C. to form the sandy soil composite.

The sandy soil includes at least 75 wt. % sand particles having a diameter ranging from about 0.02 mm to about 10 mm. In one example, sandy soil includes at least 50 wt. % sand particles having a diameter ranging from about 0.05 mm to about 2 mm. In another example, sandy soil includes at least 60 wt. % sand particles having a diameter ranging from about 0.05 mm to about 2 mm. In yet another example, sandy soil includes at least 80 wt. % sand particles having a diameter ranging from about 0.05 mm to about 2 mm. In one example, the average particle size of particles in sandy soil is greater than 0.02 mm. In another example, the average particle size of particles in sandy soil is greater than 0.1 mm. In yet another example, the average particle size of particles in sandy soil is less than 5 mm. Sandy soil may include one or more of clay and silt. In one example, the average particle diameter of silt particles ranges from about 0.05 mm to about 0.002 mm, and the average particle diameter of clay particles is less than 0.002 mm. Sandy soil may include less than 30 wt. % silt and less than 30 wt. % clay. In one example, sandy soil includes less than 20 wt. % silt. In another example, sandy soil includes less than 20 wt. % clay.

The sandy soil composite includes the cellulose fibers and the sandy soil. The weight percentage of cellulose fibers in the sandy soil may be greater than about 0.01 wt. %. In one example, the weight percentage of cellulose fibers in the sandy soil is greater than about 0.1 wt. %. In another example, the weight percentage of cellulose fibers in the sandy soil ranges from about 0.1 wt. % to about 10 wt. %. In another example, the weight percentage of cellulose fibers in the sandy soil ranges from about 0.1 wt. % to about 3 wt. %. In yet another example, the weight percentage of cellulose fibers in the sandy soil ranges from about 0.5 wt. % to about 2 wt. %.

Importantly, methods 200 and 300 can be used to form a fibrous composite with a robust cellulose network using sandy soil and additives. These fibrous composites exhibit enhanced stability, water and nutrient retention, and water and wind erosion resistance compared to conventional sandy soil. The cellulose added to sandy soil can be derived from various sources, such as plant materials. Therefore, fibrous composites may be formed using portions or products of waste materials, assisting in utilizing these otherwise unused waste materials. Importantly, the fibrous composite can be formed without using sulfuric acid hydrolysis, which is expensive. Importantly, methods 200 and 300 can be used for various substrates, such as substrates other than sandy soil. For example, methods 200 and 300 could be used in clays, silts, loams, and/or various topsoils. As stated, fibrous composites of the present disclosure can be used for enhanced plant growth compared to traditional sandy soil, and these composites can also be used for structural applications to increase stability of the structure, such as for buildings, roads, and railroad tracks.

### Example 1—Microbial Growth and Cellulose Nanofiber Production

The dissolved fraction (rich in sugars) of plant-based food waste was utilized to enhance the properties of sandy soil. Initially, microbes, cultivated from glucose and other food by-products, were introduced into desertic sandy soil, where their growth is accompanied by the production of nanofibers that enhance cohesion and water retention of said sandy soils. These sugars can be sourced from the water-dissolvable food waste fraction, including various plant-based wastes such as fruits and vegetables, or pulp and paper by-products treated with enzymes. The growth of specific cellulose-producing strains of microbes, like Acetobacteria or Komagataeibacter Mendeliesis, within the sandy network leads to the formation of a robust cellulose network. This network not only aids in microbial growth but also contributes to resistance against wind erosion and water retention-important properties for agricultural applications.

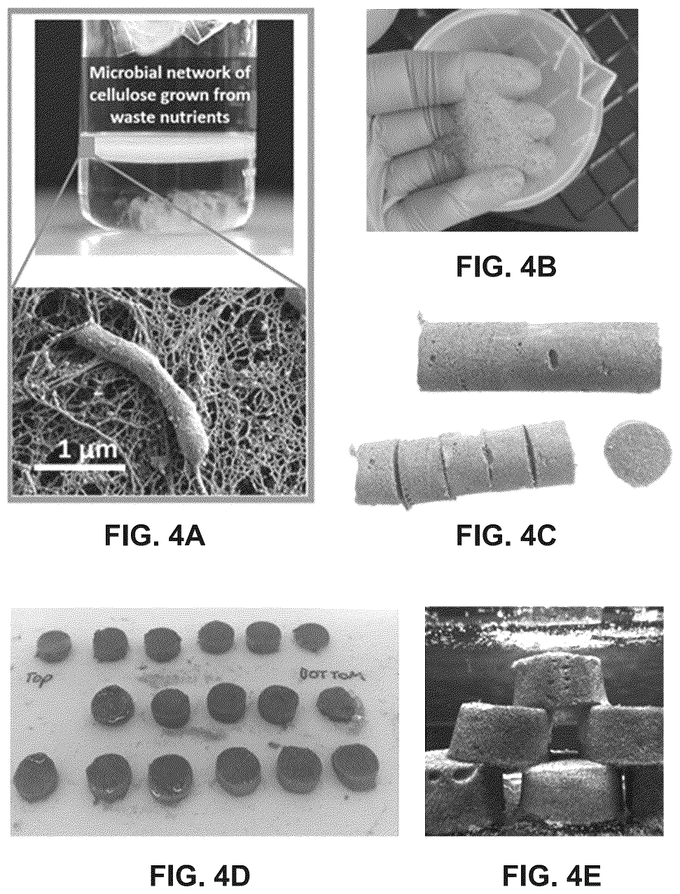

Initially, cylinders were formed by exposing sand to nutrients and a diluted concentration of microbes. These cylinders had a diameter of about 1.5 cm. FIG. 4A illustrates a microbial network of cellulose formed from waste nutrients, according to some embodiments. Subsequently, these microbes were introduced to the sand soil, enhancing its structure and augmenting water retention and uptake capabilities. FIG. 4B illustrates sandy soil to be used for in situ growth of bacteria, according to some embodiments. FIG. 4C illustrates sandy soil composites after bacterial growth, according to some embodiments. FIG. 4D illustrates sandy soil composites after bacterial growth, according to some embodiments. FIG. 4E illustrates the sandy soil composite immersed under water, highlighting its resistance to erosion and associated water retention, according to some embodiments. The pellet formation serves as a reference for testing the mechanical properties and water response of the bound sandy soils. Unlike the original sandy soil lacking cohesion, a more gel-like composite is formed after microbial growth. In one example, over 95% of the sand fraction demonstrates enhanced properties due to this treatment.

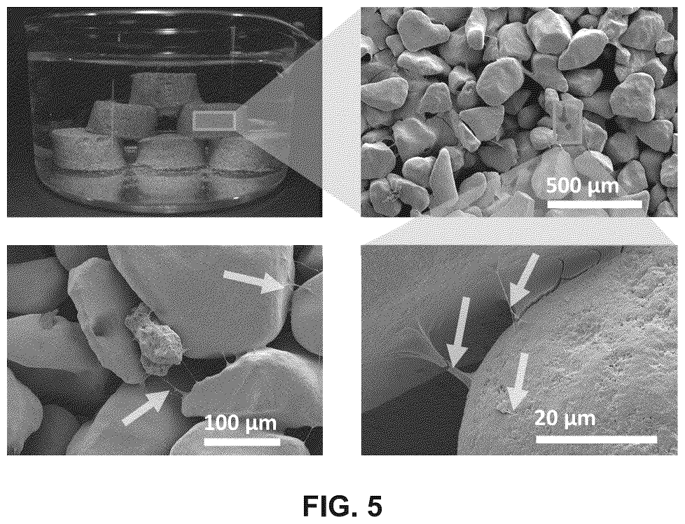

FIG. 5 illustrates the stability of sandy soil composites stabilized by bacterial exopolysaccharides in water and scanning electron microscopy (SEM) images of the sandy soil composites, according to some embodiments. By employing dissolved food waste fraction-based sand amendments, remarkable stability in sand, even under immersion in water, is achieved, as illustrated in FIG. 5. This stability is credited to the existence of a bacterial nanocellulose network, which significantly enhances cohesion within the sand matrix. Scanning electron microscopy (SEM) imaging of the stabilized sand illustrates the presence of a pervasive network of nanofibers encasing the sand granules. Moreover, the observation of small polymeric bridges near contact points in certain regions shows an elevated concentration of bacterial nanocellulose. These findings underscore the effectiveness of utilizing dissolved food waste fractions in enhancing sand stability through the incorporation of bacterial nanocellulose, showcasing applications in soil engineering and stabilization.

### Example 2—Cellulose Nanofibers Using a High-Pressure Hhomogenizer and Comparisons

Fiber networks were introduced into sandy soils using the undissolved fraction (rich in fibers) of plant wastes. Plant cells were obtained from various wastes, including fruits, vegetables, municipal trimmings, and/or pulp and paper by-products. These plant cells were processed to extract nanofibers (nanocellulose) ranging from micrometers to nanometers in size. These nanocelluloses were then used to amend sandy soil, forming solid materials with improved water retention and reduced aeolian erosion. Similar to Example 1, this approach also contributes to resistance against wind erosion, carbon fixation, and enhanced water retention in sandy soil, making it beneficial for agricultural and infrastructure purposes.

Polysaccharides exhibit intricate interactions with sandy soils, influencing fracture patterns, polymeric network formation, and particle cluster sizes. Various polysaccharides such as chitosan, carboxymethylcellulose (CMC) with different molecular weights (0.7 MDa and 0.09 MDa), hydroxypropylcellulose (HPC), pectin, mechanically fibrillated cellulose nanofibers (CNFs) with different degrees of fibrillation severity, elementary fibrils (TO-CNF), cellulose nanocrystals (CNCs), bleached kraft pulp (BKP), kraft pulp (KP), and methylcellulose were assessed for their capacity to enhance cohesion in quartz-rich sand. The compressive response of pellets was comprehensively quantified in terms of overall toughness, ultimate compressive strength (UCS), and strain at failure, and nanofibers were investigated across various concentrations.

Mechanically fibrillated cellulose nanofibers (CNFs) were prepared by mechanical disintegration from never-dried, fully bleached, and fines-free sulphite birch pulp (Kappa number of 1, DP of 4700) suspended in distilled water at 1.8% (w/v). The suspension was disintegrated using a high-pressure fluidizer (6, 9, or 12 passes, referred to as “CNF 6P”, “CNF 9P”, and “CNF 12P”, respectively). Sodium salt of carboxymethyl cellulose (CMC, molecular weight 0.7 MDa and 0.09 MDa, referred to as “CMC 0.7” and “CMC 0.09”, respectively), methylcellulose (viscosity: 15 cP), HPC (hydroxypropyl cellulose, MW 100 kDa, DS 2.232), sodium alginate (molecular weight, 12-40 kDa), chitosan (medium molecular weight, 190-310 kDa), pectin (from citrus, whole fractions with galacturonic acid ≥74.0% (dried basis) CAS Number: 9000-69-5), sodium hydroxide pellets, and hydrogen chloride (37%) were utilized. Kraft Pulp (KP, once dried), and Bleached Kraft Pulp (BKP, never dried) from Finnish birch, and commercial quartz granules (mesh size 50-70), were also utilized.

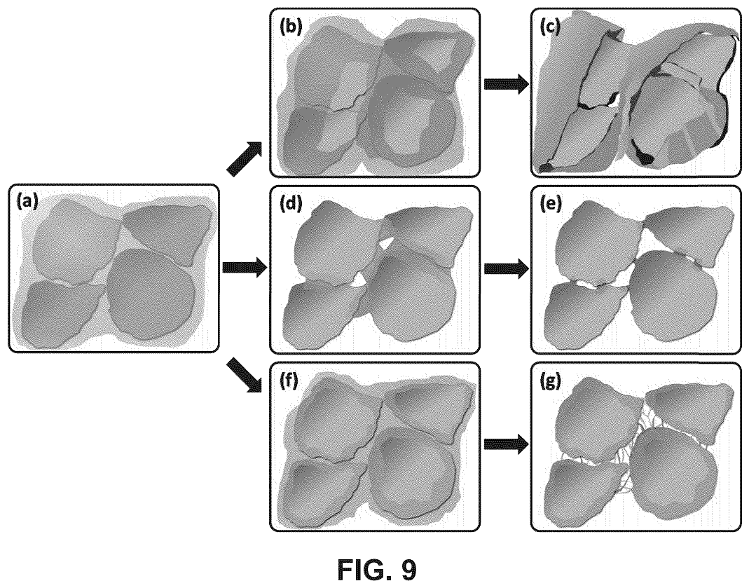

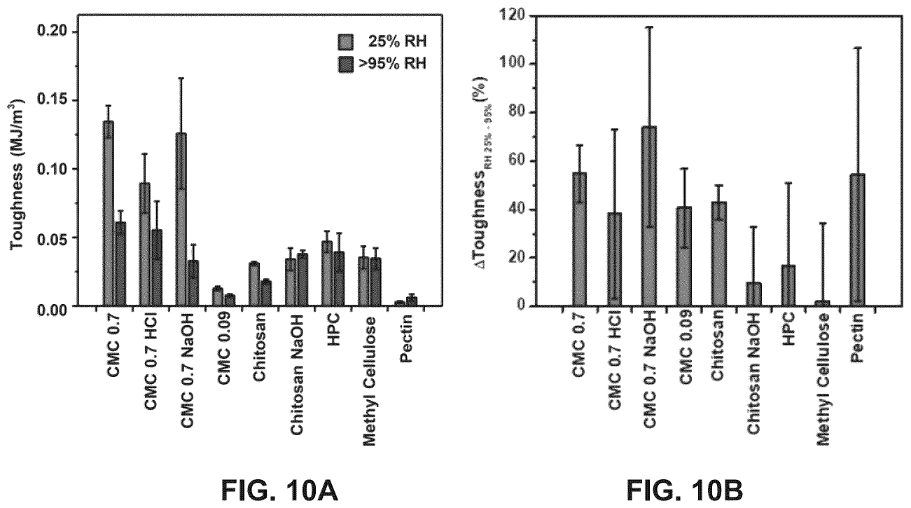

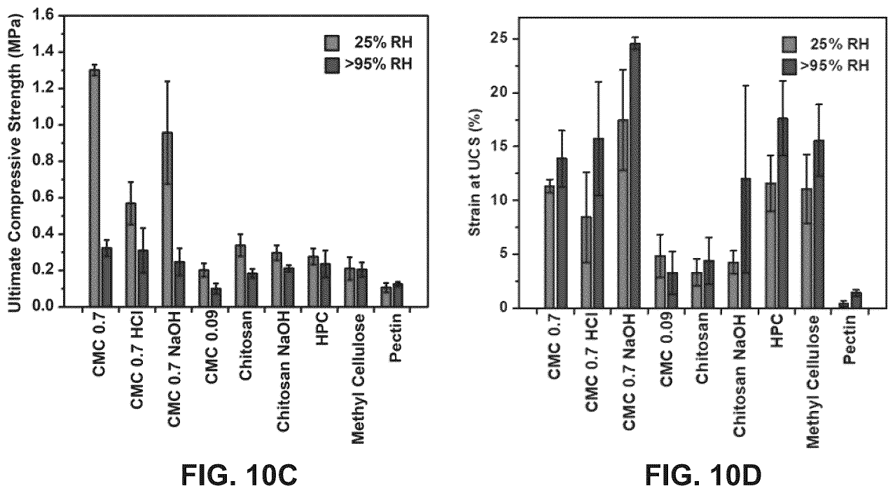

Aqueous suspensions or solutions containing 2.5 wt. % of the specified amendments were prepared using distilled water. To address the low solubility of chitosan, the polymer powder was briefly gelled with a small amount of IM HCl solution before adjusting the concentration to approximately 5 wt. % and the pH to 5, resulting in a final concentration of 2.5 wt. %. Subsequently, a fixed weight of 14 grams of sand was placed into a container, and the prepared amendments (equivalent to 2.5 wt. % or 6 grams of a solution or suspension) were introduced in two distinct methods: First, for data presented in FIG. 9, where the dispersion showed high viscosity, amendments were infiltrated into the packed sand via centrifugation. Second, for data shown in FIG. 10A-D, involving amendments like fibers, a slurry was formed through rigorous mixing and then combined with the sand using a spatula before being grouted into cylindrical 3D-printed thermoplastic polyurethane molds with dimensions of 6 mm in diameter and 6 mm in height.

The resulting pellets, weighing approximately 210 mg each and containing 1.06% of polymer by weight, were collected after drying for 4 hours at 105° C. For pH-modified samples (CMC 0.7 and chitosan), additional steps included immersion in 0.1 M NaOH or HCl followed by rinsing with deionized water. In one example, to determine effective drying methods, the effect of temperature and drying kinetics on CMC 0.7 was evaluated, revealing better strength for pellets dried at 40° C. compared to those dried at 105° C. Furthermore, adjustments in concentration were made for certain samples to achieve various fiber networks, with KP designated as KP 6X (6.36 wt. %), BKP (1.06 wt. %) as BKP 2X (2.12 wt. %), and CNFs (1.06 wt. %) as CNF 2X (2.12 wt. %). Notably, BKP and KP differed due to the drying process, with BKP undergoing no drying and KP subjected to a single drying cycle.

The mechanical fibrillation process was also conducted using a ball mill (discussed further in Example 3). Each milling chamber, with a capacity of 125 mL, contained 45-50 stainless steel balls measuring 5 mm in diameter. The fibers were milled in 2% fiber solutions, with variations in the solution composition depending on the gelling point. Following milling, the balls were separated using sieving techniques, and if necessary, the solution was condensed via centrifugation. The resulting ball-milled fibers were derived from R-PA, AT PA, and BL PA, which were then designated with the addition of “BM” to distinguish them from their original counterparts, named as R-PA BM, AT PA BM, and BL PA BM, respectively, where R-PA=raw pineapple peel, AT=Alkali treated, BL=Bleached, BM=ball milled.

Axial compression tests were conducted to assess the mechanical properties of the samples. The cylindrical samples were vertically positioned between two parallel steel plates, and the strain rate was maintained at 0.2 mm sec-1 until the measurement was halted at 50% strain. Stresses were calculated based on the cross-sectional area of the cylinder, and strength was evaluated using the maximum load. Toughness was determined over a strain of 25%. Prior to testing, the samples were allowed to equilibrate for at least 1 day at either 25% relative humidity (RH) or saturated humidity (>95% RH), and their compression response was then measured immediately at 25% RH. Each condition was tested with a minimum of 5 samples to for statistical significance.

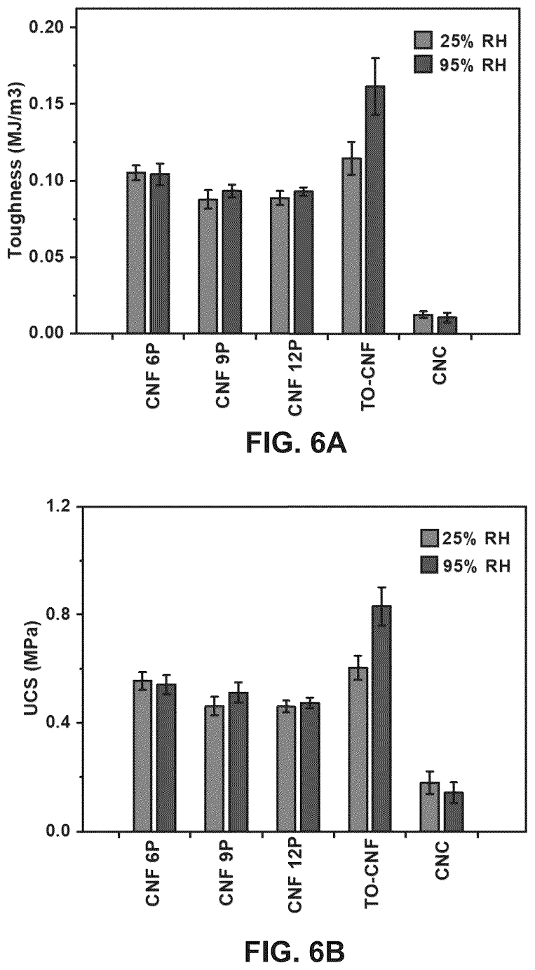

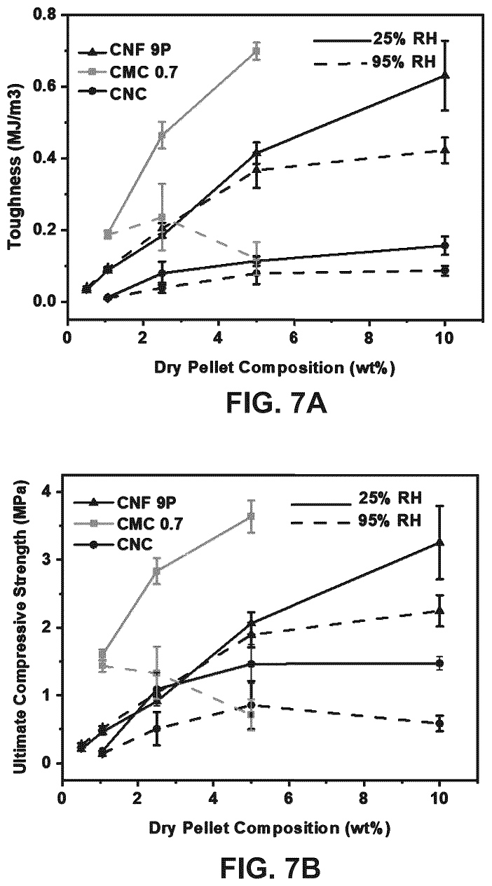

FIG. 6A illustrates toughness in MJ m⁻³ at 25% strain for 1.06% dry-weight nanocellulose in the sandy soil composite, according to some embodiments. FIG. 6B illustrates ultimate compressive strength (UCS) in MPa for the sandy soil composites as a function of added nanocellulose for 1.06% dry weight nanocellulose in the sandy soil composites, according to some embodiments. FIG. 7A illustrates toughness at 25% in MJ m⁻³ as a function of polymer composition in the sandy soil composite, according to some embodiments. FIG. 7B illustrates ultimate compressive strength (UCS) for the sandy soil composite as a function of dry weight percentage of nanocellulose, according to some embodiments.

Overall, while fibers exhibited lower toughness compared to dissolved macromolecules, their strain at the ultimate compressive strength (UCS) was typically comparable to high-performing polymeric binders such as CMC 0.7, HPC, or methylcellulose. In one example, elementary fibrils (TO-CNFs) showed enhanced toughness and strength compared to mechanically fibrillated systems, suggesting that the oxidation process and subsequent fibrillation improve the mechanical properties of sand pellets. In another example, mechanical fibrillation of CNFs demonstrated little influence on mechanical properties beyond six passes. In another example, CNCs exhibited the lowest mechanical properties attributed to their smaller aspect ratio and brittle assembly nature. For example, increasing nanocellulose content improved both toughness and strength. The interactions between biopolymers and quartz particles enhance mechanical properties and water interaction in sandy soils.

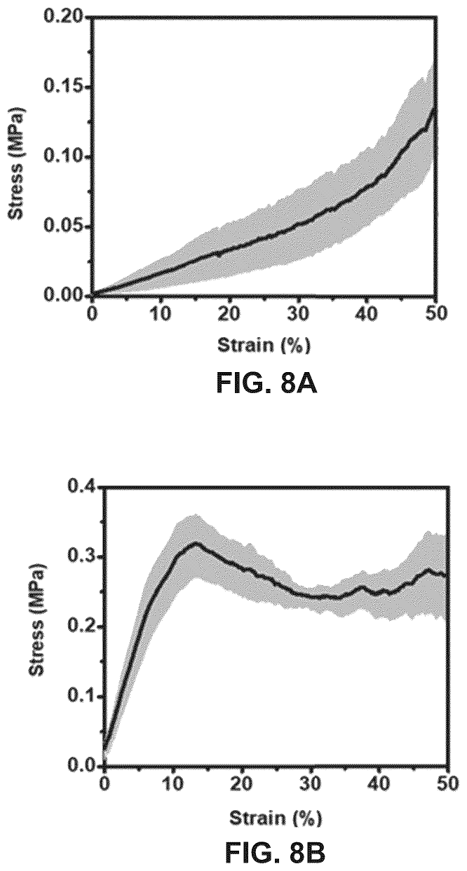

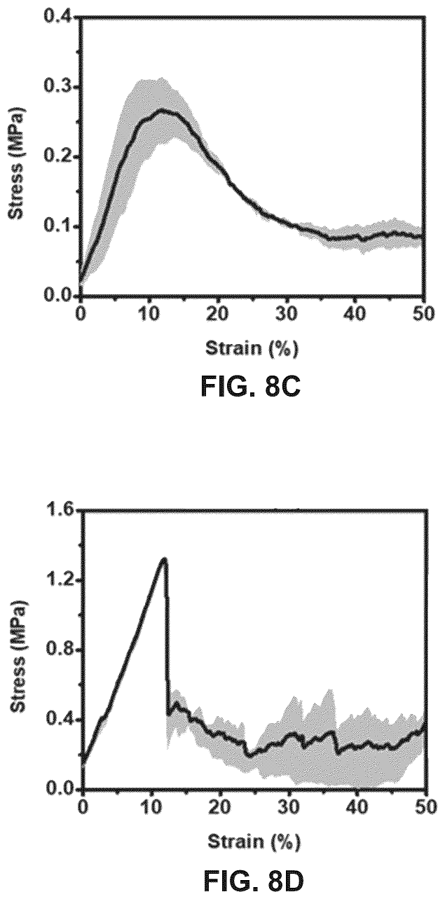

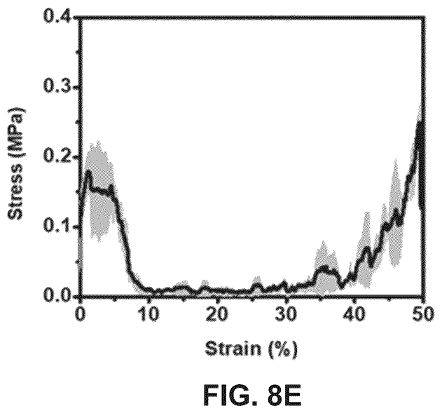

FIG. 8A illustrates representative stress-strain curves at 25% relative humidity for KP of unconfined compression tests, according to some embodiments. FIG. 8B illustrates representative stress-strain curves at 25% relative humidity for CNF 2X of unconfined compression tests, according to some embodiments. FIG. 8C illustrates representative stress-strain curves at 25% relative humidity for HPC of unconfined compression tests, according to some embodiments. FIG. 8D illustrates representative stress-strain curves at 25% relative humidity for CMC 0.7 of unconfined compression tests, according to some embodiments. FIG. 8E illustrates representative stress-strain curves at 25% relative humidity for CMC 0.09 of unconfined compression tests, according to some embodiments.

Various fracture behaviors at different strain levels were observed. These behaviors, observed through representative curves and morphological analyses, indicate distinct mechanisms of (i) plastic deformation (FIG. 8A), (ii) fracture into large fragments (FIG. 8B and FIG. 8C), or (iii) fragmentation into smaller aggregates and grains (FIG. 8D and FIG. 8E). The observed fracture patterns are attributed to the unique structures formed during consolidation, which affect the balance between polymer-polymer and polymer-sand interactions.

KP and BKP exhibited continuous plastic deformation, characterized by sustained shaping under stress, while HPC, methylcellulose, and CNF displayed semi-plastic deformation followed by the formation of large clusters upon fracture. Conversely, CMC 0.7 and pectin composites fractured into either large or small clusters above a critical load. Notably, the ultimate compression strength (UCS) sustained by the pellets varied depending on the fracture type, with type (ii) fractures exhibiting the highest values at approximately 10% strain, while type (i) fractures showed no catastrophic failure. This disparity in behavior can be attributed to differences in the conformation of the carbohydrate polymer network formed between grains, with larger clusters indicating the formation of more extensive cohesive networks, as well as cohesive and adhesive interactions within the amendment's network and at the sand interface, respectively.

FIG. 9 illustrates a flowchart showing interactions between sand granules and polymer phases, according to some embodiments. The interactions between sand granules and polymer phases during the drying process were: (a) Initial mixture state; (b and c) Drying with a polymer gelling at a low concentration, and after consolidation primarily through the formation of intergranular polymer sheets, respectively; (d and e) Drying with a polymer gelling at a high concentration, and after consolidation mainly through small capillaries following migration to capillaries between grain contact points, respectively; (f and g) Drying with chitosan, and after consolidation mainly through very thin and numerous capillaries following migration to capillaries between grain contact points, respectively. The dynamics of polymer solution gelling at different concentrations were observed, with low-concentration gels stretching within confined spaces and high-concentration gels migrating to create capillaries between sand grains before consolidation.

FIG. 10A illustrates toughness in MJ·m⁻³ for the sandy soil composites as a function of carbohydrate polymers added after a 25% strain, according to some embodiments. FIG. 10B illustrates relative change in average toughness resulting for samples exposed to 25% RH or >95% RH prior to compression, according to some embodiments. FIG. 10C illustrates corresponding ultimate compressive strength (UCS), according to some embodiments. FIG. 10D illustrates the strain at the ultimate compressive strength, according to some embodiments. Among the remaining amendments, CMC 0.7 exhibited the highest toughness (0.134 MJ·m⁻³ ), followed by CNF 6P 2X (0.097 MJ·m⁻³ ).

The toughness enhancement observed in BKP compared to KP suggested the influence of drying methods on polymer performance. Molecular weight and functional groups influenced polymer performance, with higher molecular weights and carboxymethyl functional groups correlating with superior mechanical properties. The effect of pH on polymer assembly further elucidated the intricate interplay between polymer chemistry and sand interactions, with variations observed in cohesion and UCS. Moreover, changes in humidity levels demonstrated impacts on polymer performance, particularly for charged and highly polar systems.

The observed reduction in toughness at higher humidity levels, particularly for charged polymers like CMC 0.7, underscored the role of water in altering material properties. Interestingly, while overall strength and toughness decreased with increased humidity for charged polymers, the strain at maximum load increased, indicating a potential increase in material plasticity. This shows that the hygroscopic nature of polysaccharides influenced the plastic behavior of these systems.

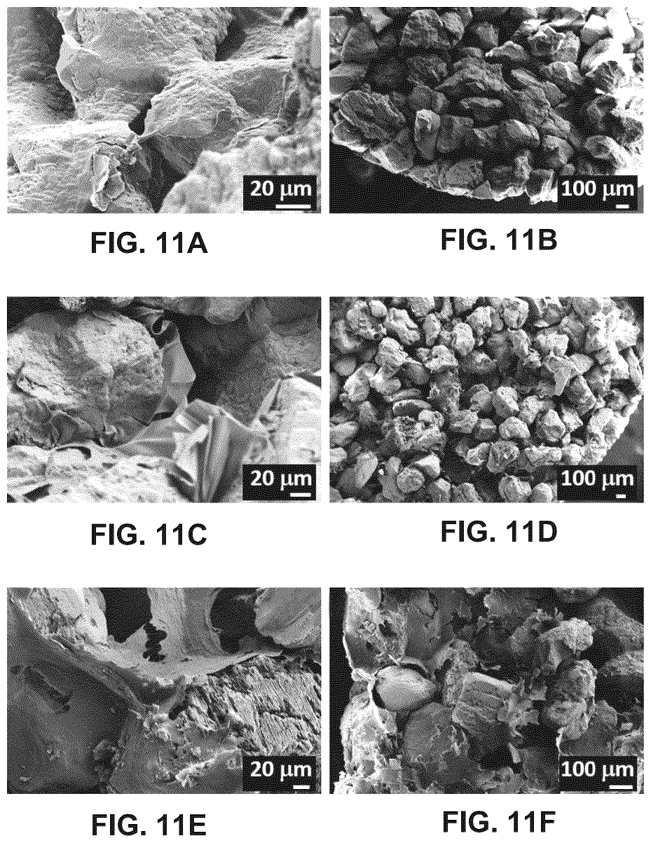

FIG. 11A illustrates a scanning electron microscopy (SEM) image of sandy soil composites formed with CMC 0.09, according to some embodiments. FIG. 11B illustrates a scanning electron microscopy (SEM) image of sandy soil composites formed with CMC 0.09, according to some embodiments. FIG. 11C illustrates a scanning electron microscopy (SEM) image of sandy soil composites formed with CMC 0.7, according to some embodiments. FIG. 11D illustrates a scanning electron microscopy (SEM) image of sandy soil composites formed with CMC 0.7, according to some embodiments. FIG. 11E illustrates a scanning electron microscopy (SEM) image of sandy soil composites formed with CNF 2X, according to some embodiments. FIG. 11F illustrates a scanning electron microscopy (SEM) image of sandy soil composites formed with CNF 2X, according to some embodiments.

Three samples, namely CNF (2X), CMC 0.09, and CMC 0.7, were closely examined based on their fracture behaviors to establish correlations between internal structure and mechanical responses. Scanning electron microscopy revealed different internal structures due to variations in gelation concentration among the organic amendments. Late gelation favored a higher concentration of polymer within small capillaries formed at sand granule contact points, while early gelation resulted in homogeneous polymer distribution within pores between granules. Additionally, shear thinning effects were observed in fiber samples like CNFs, where a honeycomb-like network enveloped the sand granules. Conversely, CMC 0.09 displayed sporadic polymeric bridges near contact points, showing consolidation at high concentrations followed by migration towards capillary bridges between granules, contrasting with CMC 0.7, which formed thick gels infiltrating sand and consolidating into observable thin films between grains.

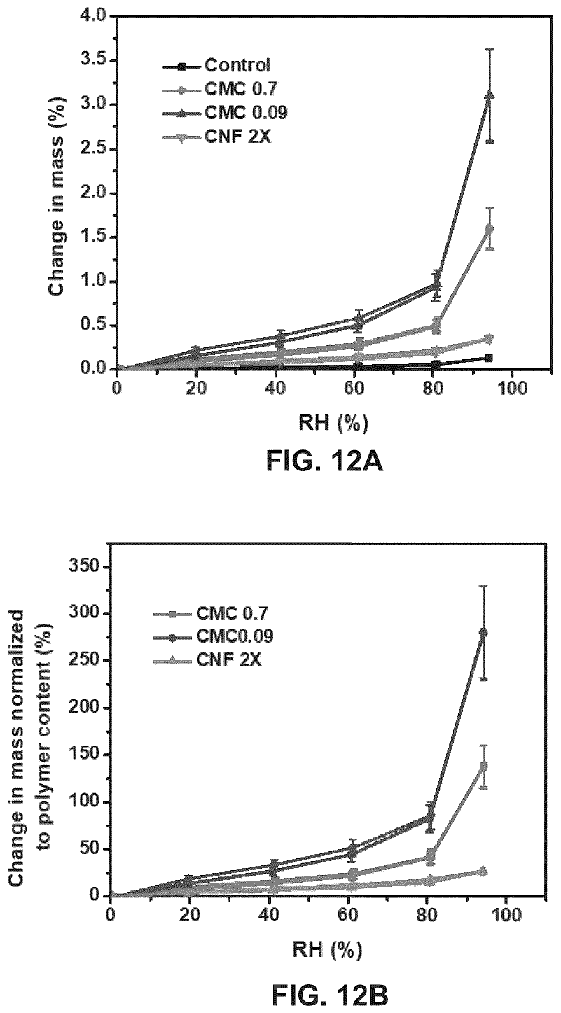

FIG. 12A illustrates changes in mass for the sandy soil composites as a function of relative humidity, according to some embodiments. FIG. 12B illustrates the mass change normalized to the polymer content after subtraction of the corresponding change in mass for the control, according to some embodiments. The sorption/desorption isotherms were analyzed using Dynamic Vapor Sorption. The nitrogen flow and temperature were maintained at constant levels of 200 sccm and approximately 25° C., respectively. Before conducting measurements, the samples underwent drying at 105° C. Subsequently, around 20 mg of each sample was loaded into the apparatus. Uptake and release isotherms were obtained by subjecting the samples to various relative humidity stages. Each sample was tested three times.

Dynamic vapor sorption experiments were conducted, revealing notable differences compared to the control, which comprised solely packed sand granules, emphasizing the significant impact of biomacromolecules on the hygroscopic response. Despite the small fraction of added biomacromolecules in the composites (1.06 wt. % for CMCs or 2.12 wt. % for CNF), the results were remarkable, particularly when normalizing water adsorption to the polymer content. CMC 0.09, CMC 0.7, and CNF 2X exhibited adsorption of nearly 300%, 150%, and 25% of their weight at 95% relative humidity (RH), respectively. This unexpected finding suggests that CMC may enhance capillary condensation, due to its localization at contact points where condensation occurs first. A slight increase in mass (<0.1%) was observed for granules without bio-based amendments above 80% RH, attributed to capillary condensation, followed by a continuous increase in mass until 80% RH, and a significant surge until 95% RH.

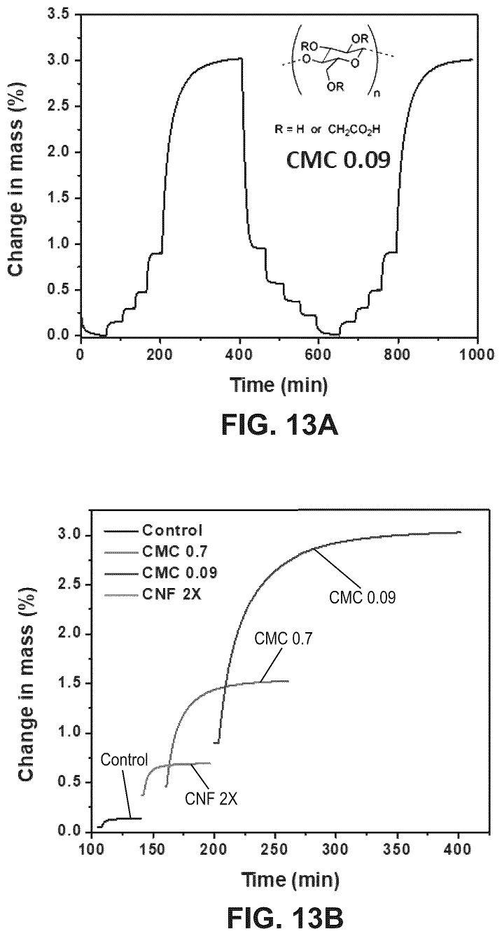

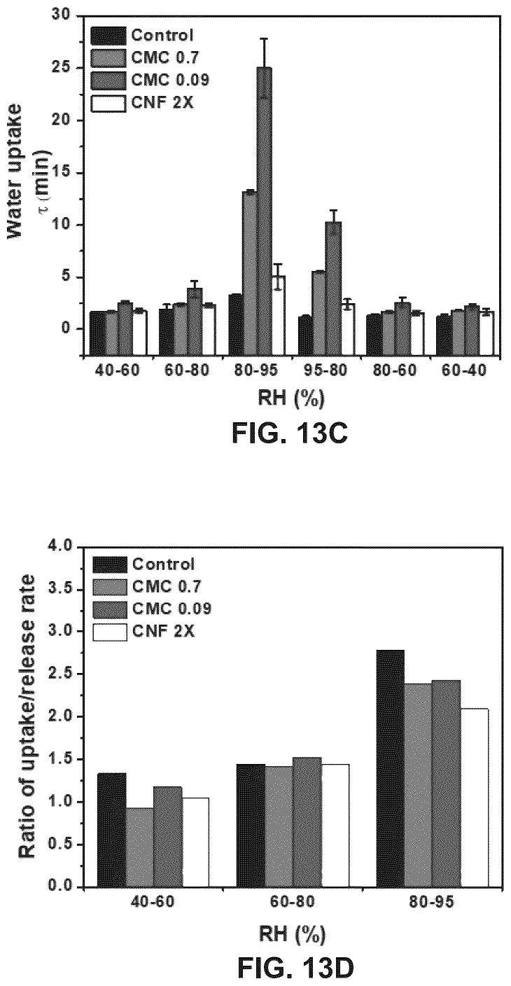

The water interaction dynamics were further examined for CMC 0.09, CMC 0.7, and CNF 2X, providing insights into their moisture sorption behaviors. FIG. 13A illustrates representative water adsorption isotherm from sandy soil composites consolidated with CMC 0.09, according to some embodiments. Dynamic water vapor sorption isotherms for CMC 0.09 reveal non-proportional dynamics between humidity transitions and between uptake and release phases. For example, the release phase exhibits faster kinetics compared to uptake, with higher humidity levels resulting in slower uptake isotherms accompanied by increased uptake quantities. FIG. 13B illustrates representative water adsorption isotherms for the 80-95 RH transition in sandy soil composites containing CMC 0.7, CMC 0.09, CNF 2X, or no amendments (control sand), according to some embodiments. FIG. 13B presents representative differences during the transition from 80% to 95% RH for the three cellulosic samples and the control without polymer, showcasing shifts in the characteristic adsorption time constant corresponding to variations in the total quantity adsorbed.

FIG. 13C illustrates water uptake constant or step response constant corresponding to the time required to reach 63.2% ((1−1/e)·100%) of the plateaued isotherm, according to some embodiments. Extracted water uptake/release constants, obtained by determining the time to reach 63.2% of the plateau value for each transition, highlight differences among the samples, with CMC 0.09 exhibiting the fastest release kinetics followed by CMC 0.7, the control, and CNF 2X. FIG. 13D illustrates the corresponding ratio of uptake to release rates, according to some embodiments. The release rate consistently outpaced uptake across various RH transitions, with larger transitions showing more pronounced trends.

### Example 3—Cellulose Nanofibers Using Ball-Milling and Comparisons

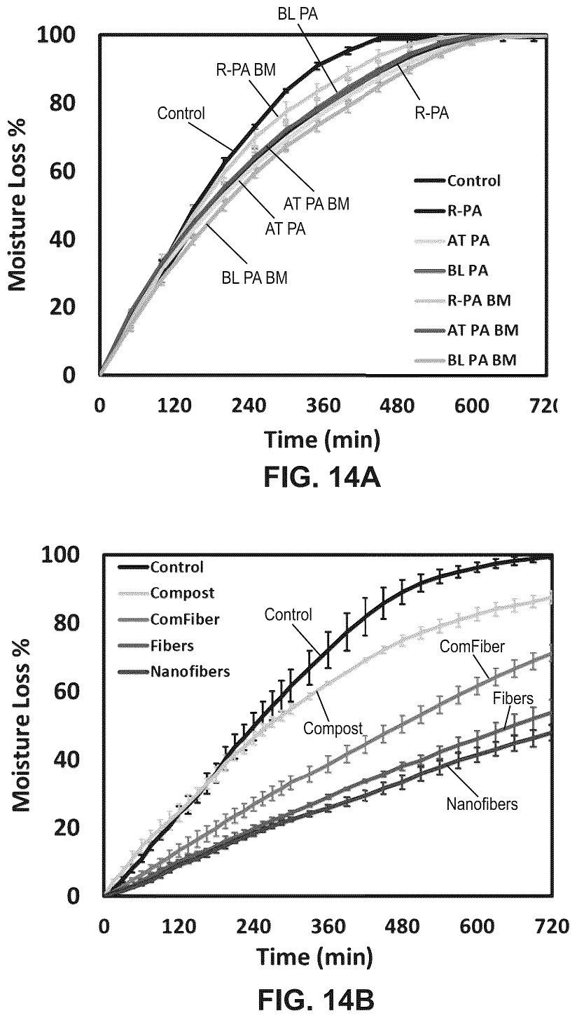

The impact of fiber chemical treatment and ball milling on moisture loss dynamics were examined. FIG. 14A illustrates moisture loss over time for fibers obtained from various treatments at 1% amendment, where R-PA=raw pineapple peel, AT=alkali treated, BL=bleached, BM=ball milled, according to some embodiments. Moisture loss experiments revealed enhanced moisture retention in soils under dry conditions upon the addition of the fiber amendment to the mixture. FIG. 14A illustrates that all amended samples exhibited improved performance compared to the control sand. The data shows that alkali treatment of the fibers enhanced performance compared to raw fibers, although a contrasting trend emerged when comparing them with the ball-milled samples. A slight decrease in water holding capacity was observed with the ball-milled fibers, potentially attributed to their increased surface area, providing more sites for water-fiber interaction. However, this may also indicate the fibers' improved ability to absorb water during irrigation. FIG. 14B illustrates a comparison of nanofibers with other sand amendments at 5% amendment, according to some embodiments. This shows a comparison between nanofibers, microfibers, and compost, revealing that nanofibers exhibited superior water retention capacity.

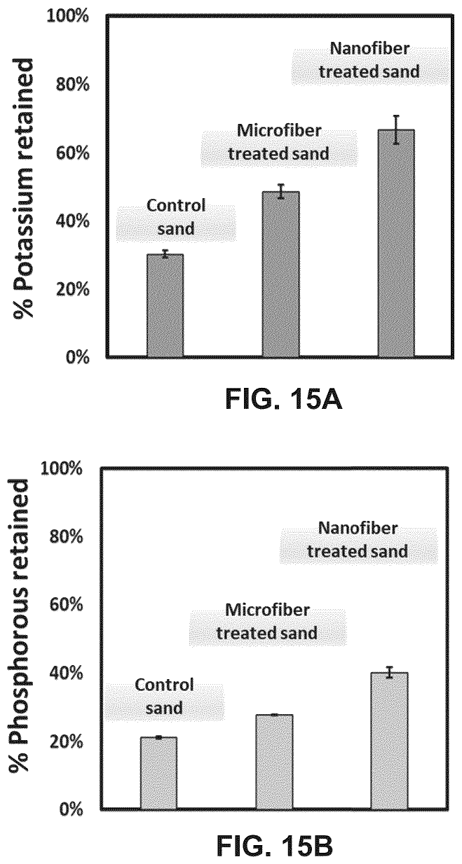

FIG. 15A illustrates potassium retention of sands, according to some embodiments. FIG. 15B illustrates phosphorus retention of sands, according to some embodiments. In one example, nanofibers showed significantly enhanced nutrient retention capabilities compared to microfibers, particularly under conditions of water overflow. Nanofibers retained up to 62% of potassium and up to 39% of phosphorus, while microfibers retained only up to 43% of potassium and 25% of phosphorus. For example, this disparity in retention rates can be attributed to the larger surface area and superior adsorption properties of nanofibers, allowing them to efficiently capture and retain a greater proportion of nutrients compared to their microfiber counterparts.

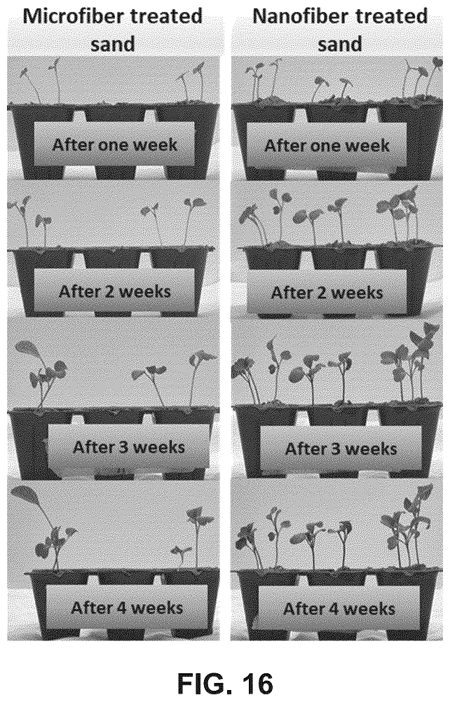

The influence of nanofiber assistance on the growth of Arugula plants was investigated over a span of four weeks. FIG. 16 illustrates plant growth using micro-and nanofiber treated sand, according to some embodiments. The growth of Arugula plants (Eruca sativa L.) was monitored for four weeks to investigate the influence of sand amendments. Plant morphology was assessed, focusing on changes such as leaf count, branch development, and total leaf surface area. Remarkable alterations in plant morphology were observed, including a notable 58% increase in the number of leaves, a 17% increase in branches, and a substantial expansion of 55% in the total surface area of leaves. These findings indicate that the inclusion of nanofibers contributed to augmented plant growth, for example, due to various factors such as enhanced nutrient uptake, elevated water retention, and reinforced structural support facilitated by the nanofiber network.

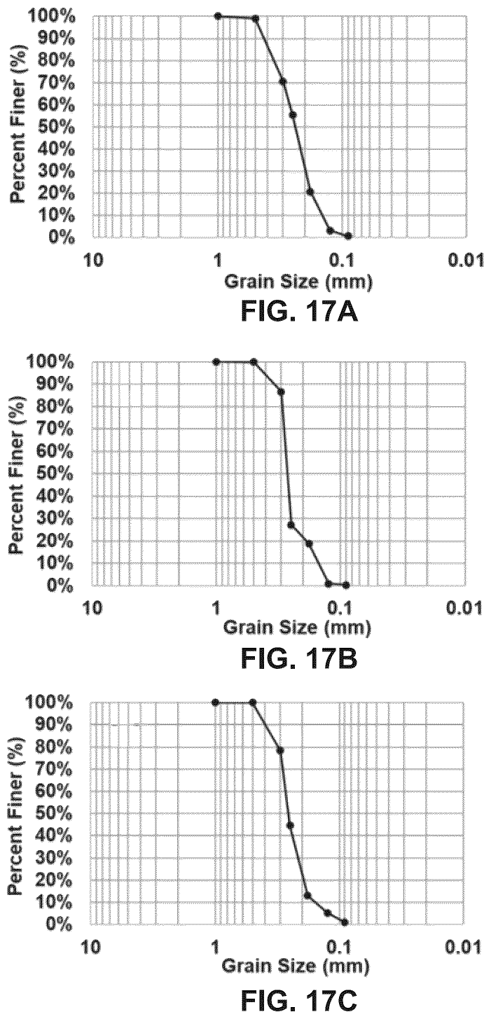

FIG. 17A illustrates sieve analysis of first sandy soil (S1), according to some embodiments. FIG. 17B illustrates sieve analysis of second sandy soil (S2), according to some embodiments. FIG. 17C illustrates sieve analysis of third sandy soil (S3), according to some embodiments. In the examples of sandy soils S1-S3, the sandy soil included less than 2 wt. % of combined clay and silt. The distribution data for S1-S3 shows the percent finer (%) in the sandy soil. In one example, the majority of particles of the sandy soil ranged from about 0.1 mm to about 0.6 mm.

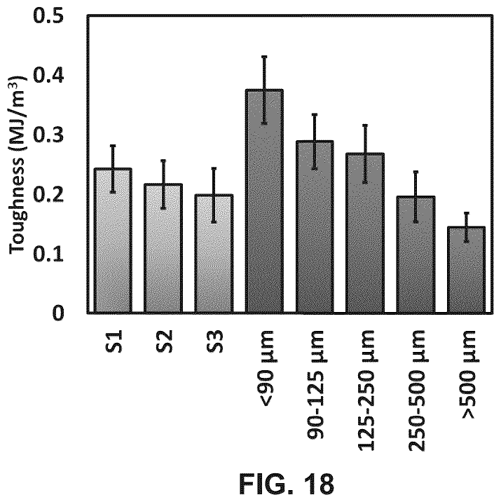

FIG. 18 illustrates toughness of sandy soils S1, size fractions of S1, S2, and S3, with CMC 0.7 utilized, according to some embodiments. The toughness (MJ/m³) was analyzed for S1, S2, and S3 from the sandy soils of FIGS. 17A-17C. Further, fractions of S1 were analyzed (<90 μm, 90-125 μm, 125-250 μm, 250-500 μm, and >500 μm. The polymer used was CMC 0.7. As shown, the toughness was generally between 0.1 and 0.5 MJ/m³.

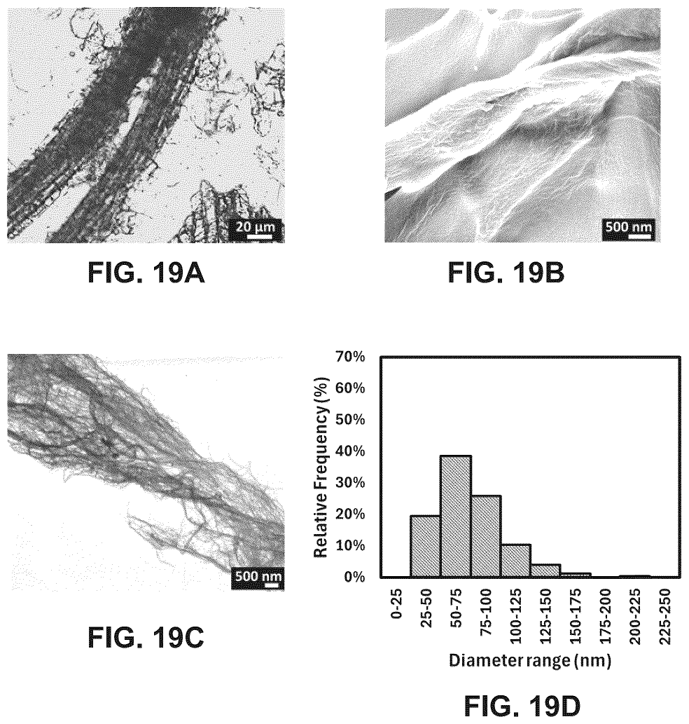

FIG. 19A illustrates morphology analysis of raw pineapple peel (R-PA), according to some embodiments. This morphology illustration is shown with a 20 μm scale. FIG. 19B illustrates morphology analysis of R-PA, according to some embodiments. This morphology illustration is shown with a 500 nm scale. FIG. 19C illustrates morphology analysis of R-PA after ball milling, according to some embodiments. This morphology illustration is shown with a 500 nm scale. FIG. 19D illustrates fiber size analysis of R-PA after ball milling (R-PA BM), according to some embodiments. As shown, the diameter in nm typically ranges from about 25 nm to about 175 nm.

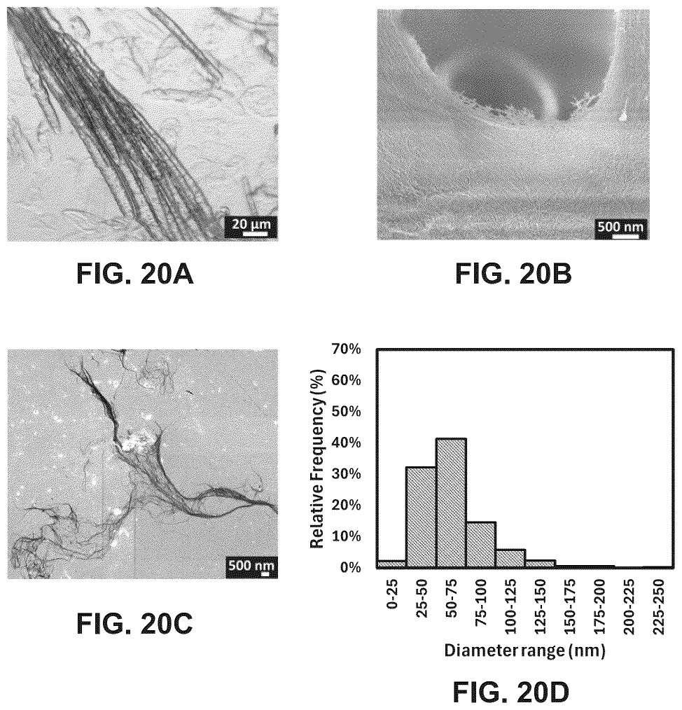

FIG. 20A illustrates morphology analysis of alkali treated pineapple pecl (ATPA), according to some embodiments. This morphology illustration is shown with a 20 μm scale. FIG. 20B illustrates morphology analysis of AT PA, according to some embodiments. This morphology illustration is shown with a 500 nm scale. FIG. 20C illustrates morphology analysis of AT PA after ball milling, according to some embodiments. This morphology illustration is shown with a 500 nm scale. FIG. 20D illustrates fiber size analysis of AT PA after ball milling (AT PA BM), according to some embodiments. As shown, the diameter in nm is typically less than about 150 nm.

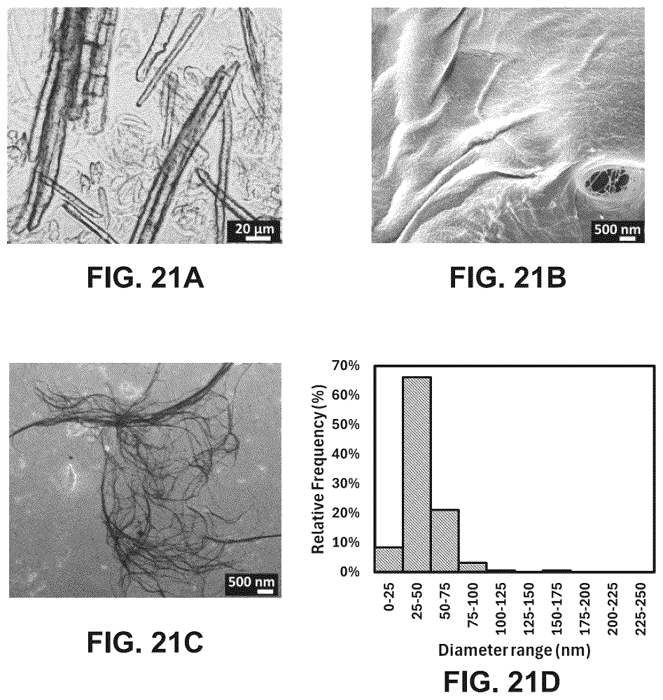

FIG. 21A illustrates morphology analysis of bleached pineapple peel (BL PA), according to some embodiments. This morphology illustration is shown with a 20 μm scale. FIG. 21B illustrates morphology analysis of BL PA, according to some embodiments. This morphology illustration is shown with a 500 nm scale. FIG. 21C illustrates morphology analysis of BL PA after ball milling, according to some embodiments. This morphology illustration is shown with a 500 nm scale. FIG. 21D illustrates fiber size analysis of BL PA after ball milling (BL PA BM), according to some embodiments. As shown, the diameter in nm typically ranges from about 1 nm to about 100 nm.

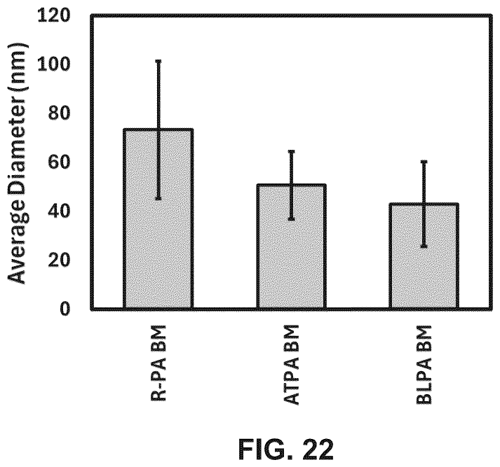

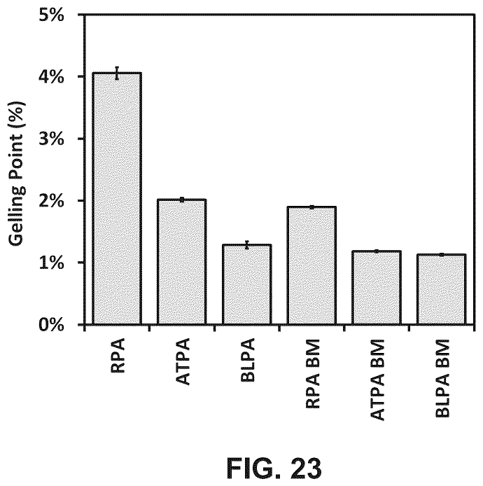

FIG. 22 illustrates the average diameter of R-PA, AT, and BL fibers after ball milling, according to some embodiments. As shown, the average diameter of R-PA BM is greater than AT PA BM and BL PA BM. The average diameters were generally greater than about 40 nm and generally less than about 80 nm. FIG. 23 illustrates the gelling point (%) of R-PA, AT PA, and BL PA, with and without ball milling, according to some embodiments. The gelling point (%) generally ranged from about 1% to about 4%. R-PA exhibited the highest gelling point at about 4%.

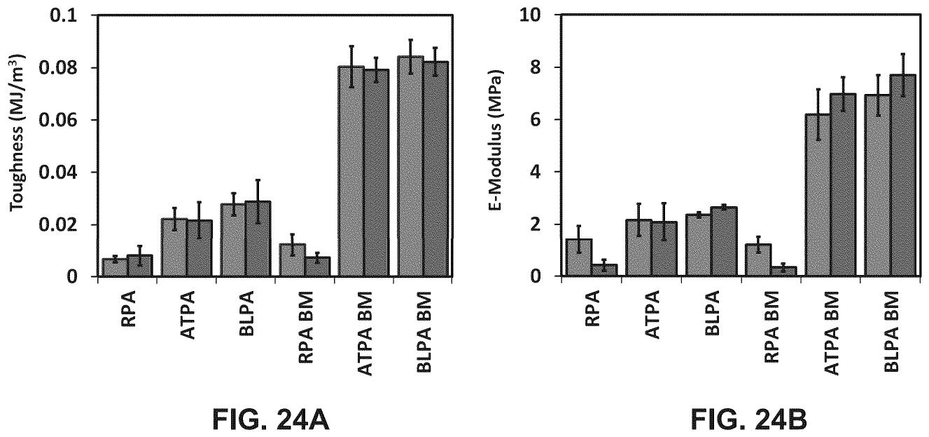

FIG. 24A illustrates toughness of R-PA, AT PA, and BL PA, with and without ball milling, according to some embodiments. As shown, alkali treatment and bleaching greatly increased the toughness in MJ/m³. For example, alkali treatment and bleaching at least doubled the toughness. FIG. 24B illustrates E-modulus of R-PA, AT PA, and BL PA, with and without ball milling, according to some embodiments. As shown, alkali treatment and bleaching increased the E-modulus in MPa. For example, alkali treatment and bleaching at least doubled the E-modulus. In FIGS. 24A-24B, analysis at 23% relative humidity is shown in the left rectangle (lighter shade) for each type, and analysis at greater than 95% relative humidity is shown in the right rectangle (darker shade).

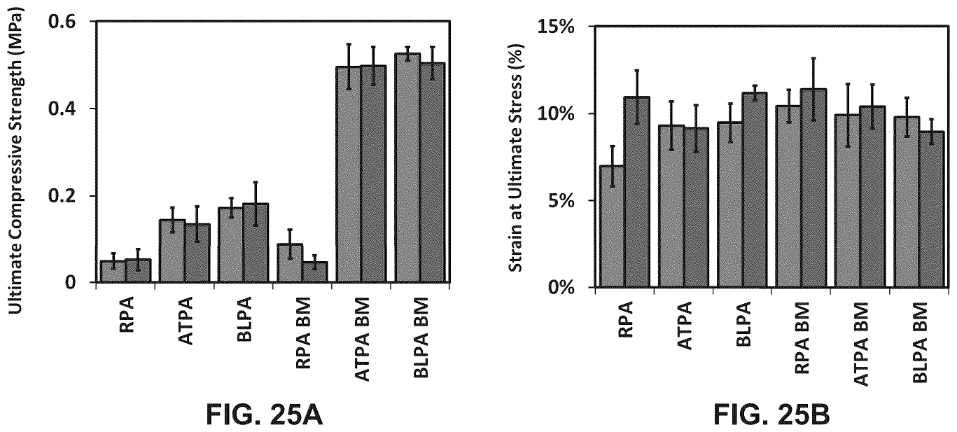

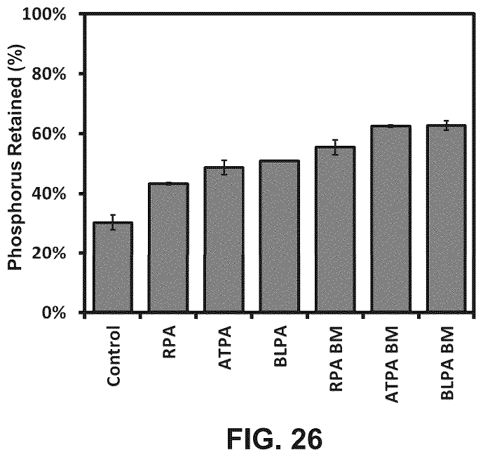

FIG. 25A illustrates ultimate compressive strength of R-PA, AT PA, and BL PA, with and without ball milling, according to some embodiments. As shown, alkali treatment and bleaching increased the ultimate compressive strength. FIG. 25B illustrates strain at ultimate stress of R-PA, AT PA, and BL PA, with and without ball milling, according to some embodiments. In FIGS. 25A-25B, analysis at 23% relative humidity is shown in the left rectangle for each type (lighter shade), and analysis at greater than 95% relative humidity is shown in the right rectangle (darker shade). FIG. 26 illustrates phosphorous retained (%) for control and for R-PA, AT PA, and BL PA, with and without ball milling, according to some embodiments. As shown, the percentage of phosphorus retained was greater for the sandy soil composites prepared using ball milling compared to sandy soil composites prepared without using ball milling.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

What is claimed is:

1. A method for forming a fibrous network in a substrate, the method comprising:
introducing a first additive and a second additive to sandy soil sufficient to form a fibrous composite, wherein the first additive includes one or more sugars, and wherein the second additive includes microbes.

2. The method of claim 1, wherein the one or more sugars are obtained from organic waste.

3. The method of claim 1, wherein the one or more sugars are obtained from plant material.

4. The method of claim 3, wherein the plant material includes at least one of fruit, stems, and leaves.

5. The method of claim 3, wherein the plant material has been mechanically processed sufficiently to form a dissolved fraction and an undissolved fraction, wherein the one or more sugars are included in the dissolved fraction.

6. The method of claim 1, wherein the one or more sugars include at least one of ribose, glucose, fructose, and sucrose.

7. The method of claim 1, wherein the microbes are capable of excreting exopolysaccharides.

8. The method of claim 1, wherein the microbes include one or more of Acetobacteriamicrobes and Komagataeibacter Mendeliesis microbes.

9. The method of claim 1, wherein the fibrous composite includes nanocellulose fibers.

10. The method of claim 1, wherein the sandy soil includes at least 75 wt. % sand particles having a diameter ranging from about 0.02 mm to about 10 mm.

11. The method of claim 1, wherein the sandy soil includes at least 80 wt. % sand particles having a diameter ranging from about 0.05 mm to about 2 mm.

12. A method for forming a fibrous network in a substrate, the method comprising:
introducing cellulose fibers to sandy soil sufficient to form a fibrous composite, wherein the cellulose fibers include mechanically processed cellulose fibers using a ball-milling process or a high-pressure homogenizer.

13. The method of claim 12, wherein the mechanically processed cellulose fibers include nanocellulose fibers.

14. The method of claim 12, wherein the mechanically processed cellulose fibers include cellulose fibers from organic material, wherein the organic material includes one or more of fruits, vegetables, stalks, trunks, leaves, pulp, and paper by-products.

15. The method of claim 12, wherein the mechanically processed cellulose fibers are further subjected to alkali treatment.

16. The method of claim 15, wherein the mechanically processed cellulose fibers are further subjected to one or more of bleaching and tempo oxidation.

17. The method of claim 12, wherein the sandy soil includes at least 75 wt. % sand particles having a diameter ranging from about 0.02 mm to about 10 mm.

18. The method of claim 12, wherein the sandy soil includes at least 80 wt. % sand particles having a diameter ranging from about 0.05 mm to about 2 mm.

19. A method for forming a sandy soil composite, the method comprising:
(a) blending one or more plant materials, wherein the one or more plant materials include cellulose fibers;
(b) treating the one or more plant materials; and
(c) introducing the cellulose fibers to sandy soil, wherein the sandy soil includes at least 75 wt. % sand particles having a diameter ranging from about 0.02 mm to about 10 mm.

20. The method of claim 19, wherein step (a) is performed before step (b), and wherein treating the one or more plant materials includes ball-milling the one or more plant materials.
